(19) United States
(12) Patent Application Publication
(10) Pub. No.: US 2017/0069059 A1
(43) Pub. Date: Mar. 9, 2017

(54) Non-Local Image Denoising

(71) Applicant: Huawei Technologies Co., Ltd., Shenzhen (CN)

(72) Inventors: Onay Urfalioglu, Munich (DE); Ibrahim Halfaoui, Munich (DE); Giovanni Cordara, Munich (DE)

(21) Appl. No.: 15/355,660

(22) Filed: Nov. 18, 2016

Related U.S. Application Data
(63) Continuation of application No. PCT/EP2014/074495, filed on Nov. 13, 2014.

(51) Int. Cl. G06T 5/00; G06K 9/52; G06T 1/60; G06K 9/62

(52) U.S. Cl. CPC G06T 5/00; G06K 9/6215; G06K 9/52; G06T 1/60; G06T 2207/20021; G06T 2207/20048

(57) ABSTRACT

An image processing apparatus for processing a digital image, where the digital image comprises a reference block and a plurality of further blocks, and where the image processing apparatus comprises a determiner being configured to determine a plurality of similarity measures between the reference block and the plurality of further blocks, wherein each similarity measure indicates a similarity between a noise distribution in the reference block and a noise distribution in a further block of the plurality of further blocks, and the determiner being further configured to determine a plurality of similar blocks from the plurality of further blocks upon the basis of the plurality of similarity measures.

### CROSS-REFERENCE TO RELATED APPLICATION

This application is a continuation of International Application No. PCT/EP2014/074495, filed on Nov. 13, 2014, the disclosure of which is hereby incorporated by reference in its entirety.

### TECHNICAL FIELD

The application relates to the field of digital image processing, in particular to de-noising of digital images.

### BACKGROUND

In digital image processing applications, noise reduction is an important task. Although modern digital image sensors may provide an improved image quality, noise may still be present in digital images e.g. due to physical effects and limitations of the digital images sensors. In particular for smart-phone cameras, noise removal can be more challenging because of a decreased pixel size of the digital image sensors.

Algorithmic solutions for an effective noise reduction can be applied in order to recover de-noised digital images with an improved visual quality. Different techniques can be used for noise reduction, e.g. block-based methods, transform domain methods, machine learning based methods, spatial domain methods, and/or hybrid methods. For example, block-based methods can take advantage of a similarity of small blocks inside the digital image of interest.

In K. Dabov, A. Foi, V. Katvonik, and K. Egiazarian, “Image Denoising by Sparse 3D Transform-Domain Collaborative Filtering,” IEEE Image Processing, vol. 16, no. 8, pp. 2080-2095, 2007, an approach for de-noising a digital image is described.

In A. Buades, B. Coll, J. M. Morel, “A non-local algorithm for image denoising”, IEEE Computer Vision and Pattern Recognition 2005, Vol. 2, pp. 60-65, 2005, a further approach for de-noising a digital image is described.

### SUMMARY

It is an object of the application to provide an efficient concept for processing a digital image, and in particular an efficient concept for processing a digital image enabling improved block matching and noise reduction performance.

This object is achieved by the features of the independent claims. Further implementation forms are apparent from the dependent claims, the description and the figures.

Aspects and implementation forms of the application are based on the finding that common approaches usually assume a stationary noise distribution and/or a Gaussian noise distribution with a constant single standard deviation across the entire digital image. However, in practice, this assumption is typically not valid. Therefore, common approaches may suffer from a reduced block matching and noise reduction performance.

Aspects and implementation forms of the application are further based on the finding that noise statistics within the digital image can depend on local properties of the digital image, e.g. image feature measures such as intensity, luminosity or texture. Thus, a non-stationary noise model is suggested, wherein the noise statistics may not evince the same standard deviation across the entire digital image.

For processing the digital image, a block matching within the digital image can be performed, wherein a plurality of similar blocks with regard to a reference block can be determined upon the basis of a plurality of similarity measures indicating a similarity between corresponding noise distributions. Therefore, a non-stationary noise model can be considered when processing the digital image. Based on the block matching, an efficient filtering and de-noising of the digital image can be performed to provide a de-noised digital image.

According to a first aspect, the application relates to an image processing apparatus for processing a digital image, the digital image comprising a reference block and a plurality of further blocks, the image processing apparatus comprising a determiner being configured to determine a plurality of similarity measures between the reference block and the plurality of further blocks, wherein each similarity measure indicates a similarity between a noise distribution in the reference block and a noise distribution in a further block of the plurality of further blocks, the determiner being further configured to determine a plurality of similar blocks from the plurality of further blocks upon the basis of the plurality of similarity measures. Thus, an efficient concept for processing a digital image can be realized.

The image processing apparatus can enable an efficient block matching within digital images, wherein the digital images may e.g. comprise non-stationary Gaussian noise.

The term “plurality” can refer to “one or more”. That is, the plurality of further blocks can be one or more further blocks, the plurality of similarity measures can be one or more similarity measures, and the plurality of similar blocks can be one or more similar blocks.

In a first implementation form of the image processing apparatus according to the first aspect as such, each similarity measure further indicates a similarity between an intensity distribution in the reference block and an intensity distribution in the further block of the plurality of further blocks. Thus, the plurality of similarity measures can indicate a similarity of noise distributions as well as a similarity of intensity distributions.

Each similarity measure can indicate a quadratic distance between the intensity distribution in the reference block and the intensity distribution in the further block.

In a second implementation form of the image processing apparatus according to the first aspect as such or any preceding implementation form of the first aspect, the determiner is configured to partition the digital image into a plurality of blocks, and to determine the reference block and the plurality of further blocks from the plurality of blocks. Thus, a partitioning of the digital image can be realized efficiently.

The reference block and the plurality of further blocks can be over-lapping.

In a third implementation form of the image processing apparatus according to the first aspect as such or any preceding implementation form of the first aspect, a size of the reference block and a size of a further block of the plurality of further blocks are equal, or a reference block and/or a further block of the plurality of further blocks is rectangular. Thus, an efficient processing of the reference block and the plurality of further blocks can be realized.

The reference block and/or the further block of the plurality of further blocks can be square and may e.g. comprise k×k pixels.

In a fourth implementation form of the image processing apparatus according to the first aspect as such or any preceding implementation form of the first aspect, the plurality of further blocks is arranged within a search window area associated with the reference block, wherein the search window area comprises the reference block, and wherein the search window area has a predetermined size. Thus, the plurality of similar blocks can be determined efficiently.

The plurality of further blocks and/or the plurality of similar blocks can be arranged in vicinity to the reference block.

In a fifth implementation form of the image processing apparatus according to the first aspect as such or any preceding implementation form of the first aspect, the determiner is configured to determine a reference noise indicator indicating the noise distribution in the reference block, to determine a plurality of further noise indicators indicating the noise distributions in the plurality of further blocks, and to combine the reference noise indicator with the plurality of further noise indicators to determine the plurality of similarity measures between the reference block and the plurality of further blocks. Thus, the plurality of similarity measures can be determined efficiently.

The reference noise indicator can indicate a standard deviation of the noise distribution in the reference block. The plurality of further noise indicators can indicate standard deviations of the noise distributions in the plurality of further blocks.

Combining the reference noise indicator with the plurality of further noise indicators can comprise subtracting the plurality of further noise indicators from the reference noise indicator. Combining the reference noise indicator with the plurality of further noise indicators can further comprise determining an absolute value of the difference. Combining the reference noise indicator with the plurality of further noise indicators can further comprise multiplying the absolute value by a predetermined scaling factor.

In a sixth implementation form of the image processing apparatus according to the fifth implementation form of the first aspect, the determiner is configured to determine a reference image feature measure, in particular an average intensity, of the reference block, to determine a plurality of further image feature measures, in particular average intensities, of the plurality of further blocks, to determine the reference noise indicator upon the basis of the reference image feature measure, and to determine the plurality of further noise indicators upon the basis of the plurality of further image feature measures. Thus, local properties of the digital image can be considered.

The reference image feature measure and/or the plurality of further image feature measures can further be an average gradient or an average luminosity.

In a seventh implementation form of the image processing apparatus according to the sixth implementation form of the first aspect, the image processing apparatus further comprises a memory, wherein the memory is configured to store a plurality of stored image feature measures and a plurality of stored noise indicators, wherein each stored image feature measure is associated with a stored noise indicator, and wherein the determiner is configured to compare the reference image feature measure and/or a further image feature measure with the plurality of stored image feature measures in the memory, and to retrieve a stored noise indicator from the memory being associated with a stored image feature measure corresponding to the reference image feature measure and/or the further image feature measure. Thus, a pre-stored mapping of image feature measures to noise indicators can be used in order to determine the noise indicators. The pre-stored mapping can e.g. be implemented using a look-up table in the memory.

In an eighth implementation form of the image processing apparatus according to the seventh implementation form of the first aspect, the image processing apparatus further comprises a further determiner, wherein the further determiner is configured to determine a plurality of image feature measures and a plurality of noise indicators upon the basis of a plurality of further digital images, wherein each image feature measure is associated with a noise indicator, and wherein the further determiner is configured to store the determined plurality of image feature measures and the determined plurality of noise indicators in the memory. Thus, an offline pre-calculation of the pre-stored mapping can be realized.

The further determiner can be configured to perform a statistical analysis upon the basis of the plurality of further digital images. The further determiner can be configured to derive an image feature measure to noise indicator mapping.

In a ninth implementation form of the image processing apparatus according to the first aspect as such or any preceding implementation form of the first aspect, the image processing apparatus further comprises a de-noising filter, the de-noising filter being configured to arrange the reference block and the plurality of similar blocks to form a 3-dimensional (3D) array, and to collaboratively filter the 3D array to obtain a filtered reference block and a plurality of filtered similar blocks. Thus, an efficient filtering of the reference block and the plurality of similar blocks can be realized.

The image processing apparatus can provide an efficient filtering of digital images, wherein the digital images can e.g. comprise non-stationary Gaussian noise. The filtering can be performed in 3 dimensions. The filtering can comprise a hard threshold filtering and/or a Wiener filtering.

In a tenth implementation form of the image processing apparatus according to the ninth implementation form of the first aspect, the determiner is configured to determine a reference noise indicator indicating the noise distribution in the reference block, and to determine a plurality of further noise indicators indicating the noise distributions in the plurality of further blocks, wherein the de-noising filter is configured to collaboratively filter the 3D array upon the basis of the reference noise indicator associated with the reference block and further noise indicators associated with the plurality of similar blocks. Thus, noise distributions in the reference block and in the plurality of similar blocks can be considered. Consequently, a modified hard threshold filtering and/or a modified Wiener filtering can be employed.

In an eleventh implementation form of the image processing apparatus according to the ninth implementation form or the tenth implementation form of the first aspect, the de-noising filter is configured to transform the 3D array from a spatial domain into a transform domain to obtain a transformed 3D array, to collaboratively filter the transformed 3D array in the transform domain to obtain a filtered transformed 3D array, and to inversely transform the filtered transformed 3D array from the transform domain into the spatial domain to obtain the filtered reference block and the plurality of filtered similar blocks. Thus, the filtering can be performed efficiently.

The transform domain can be a spatial frequency domain. The transformation can be performed upon the basis of a discrete Fourier transform (DFT) or a fast Fourier transform (FFT). The inverse transformation can be performed upon the basis of an inverse discrete Fourier transform (IDFT) or an inverse fast Fourier transform (IFFT).

The collaborative filtering in the transform domain, e.g. the hard threshold filtering or Wiener filtering, can be performed on coefficients of the 3D array in the transform domain.

In a twelfth implementation form of the image processing apparatus according to the ninth implementation form to the eleventh implementation form of the first aspect, the image processing apparatus further comprises a combiner, the combiner being configured to combine the filtered reference block with the plurality of filtered similar blocks to obtain a de-noised digital image. Thus, a de-noised digital image can be provided efficiently.

The image processing apparatus can enable an efficient de-noising of digital images, wherein the digital images can e.g. comprise non-stationary Gaussian noise.

The combining can comprise a weighting of the filtered reference block and/or the plurality of filtered similar blocks upon the basis of associated similarity measures. The combining can realize an aggregation weighting.

In a thirteenth implementation form of the image processing apparatus according to the twelfth implementation form of the first aspect, the determiner is configured to determine a reference position indicator indicating a position of the reference block within the digital image, and to determine a plurality of position indicators indicating positions of the plurality of similar blocks within the digital image, and the combiner is configured to combine the filtered reference block with the plurality of filtered similar blocks upon the basis of the determined reference position indicator and the determined plurality of position indicators. Thus, an efficient combination of the filtered reference block with the plurality of filtered similar blocks can be realized.

The reference position indicator and/or the plurality of position indicators can comprise a pixel coordinate within the digital image.

According to a second aspect, the application relates to a method for processing a digital image, the digital image comprising a reference block and a plurality of further blocks, the method comprising determining a plurality of similarity measures between the reference block and the plurality of further blocks, wherein each similarity measure indicates a similarity between a noise distribution in the reference block and a noise distribution in a further block of the plurality of further blocks, and determining a plurality of similar blocks from the plurality of further blocks upon the basis of the plurality of similarity measures. Thus, an efficient concept for processing a digital image can be realized.

First to thirteenth implementation forms of the second aspect correspond to the first to thirteenth implementation forms of the first aspect.

The method can be performed by the image processing apparatus. Further features of the method can directly result from the functionality of the image processing apparatus.

According to a third aspect, the application relates to a computer program comprising a program code for performing the method according to the second aspects or any of the implementation forms of the second aspect when executed on a computer. Thus, the method can be performed automatically.

The image processing apparatus, e.g. the determiner, the de-noising filter, the combiner and/or the further determiner, can be programmably arranged to perform the computer program.

According to a fourth aspect, the functionalities of the image processing apparatus, e.g. the determiner, the de-noising filter, the combiner and/or the further determiner, can be arranged to be implemented in a single processor or in different processors, e.g. each in a different processor.

First to thirteenth implementation forms of the fourth aspect correspond to the first to thirteenth implementation forms of the first aspect.

Aspects and implementation forms of the application can be implemented in hardware and/or software.

### BRIEF DESCRIPTION OF THE DRAWINGS

Embodiments of the application will be described with respect to the following figures, in which:

FIG. 1 shows a diagram of an image processing apparatus for processing a digital image according to an embodiment;

FIG. 2 shows a diagram of a method for processing a digital image according to an embodiment;

FIG. 3 shows a diagram of an image processing apparatus for processing a digital image according to an embodiment;

FIG. 4 shows a diagram of a determiner for determining a plurality of similarity measures between a reference block and a plurality of further blocks according to an embodiment;

FIG. 5 shows a diagram of a digital image and a 3D array according to an embodiment;

FIG. 6 shows a diagram of collaboratively filtering a 3D array by a de-noising filter according to an embodiment;

FIG. 7 shows a diagram of a de-noising filter for collaboratively filtering a 3D array according to an embodiment;

FIG. 8 shows a diagram of combining a filtered reference block with a plurality of filtered similar blocks by a combiner to obtain a de-noised digital image;

FIG. 9 shows a diagram of a further determiner for determining a plurality of image feature measures and a plurality of noise indicators upon the basis of a plurality of further digital images according to an embodiment; and

FIG. 10 shows a diagram of a plurality of stored image feature measures and a plurality of stored noise indicators being arranged to form a measure-to-noise map according to an embodiment.

### DETAILED DESCRIPTION

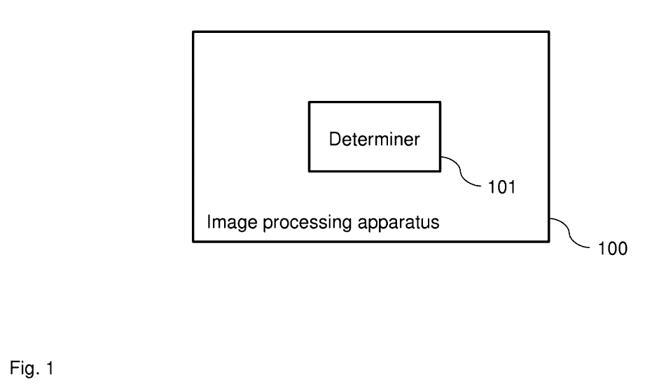

FIG. 1 shows a diagram of an image processing apparatus 100 for processing a digital image according to an embodiment. The digital image comprises a reference block and a plurality of further blocks.

The image processing apparatus comprises a determiner 101 being configured to determine a plurality of similarity measures between the reference block and the plurality of further blocks, wherein each similarity measure indicates a similarity between a noise distribution in the reference block and a noise distribution in a further block of the plurality of further blocks, the determiner 101 being further configured to determine a plurality of similar blocks from the plurality of further blocks upon the basis of the plurality of similarity measures.

The image processing apparatus 100 can further comprise a de-noising filter, the de-noising filter being configured to arrange the reference block and the plurality of similar blocks to form a 3D array, and to collaboratively filter the 3D array to obtain a filtered reference block and a plurality of filtered similar blocks.

The image processing apparatus 100 can further comprise a combiner, the combiner being configured to combine the filtered reference block with the plurality of filtered similar blocks to obtain a de-noised digital image.

The image processing apparatus 100 can further comprise a further determiner, wherein the further determiner is configured to determine a plurality of image feature measures and a plurality of noise indicators upon the basis of a plurality of further digital images, wherein each image feature measure is associated with a noise indicator, and wherein the further determiner is configured to store the determined plurality of image feature measures and the determined plurality of noise indicators in a memory.

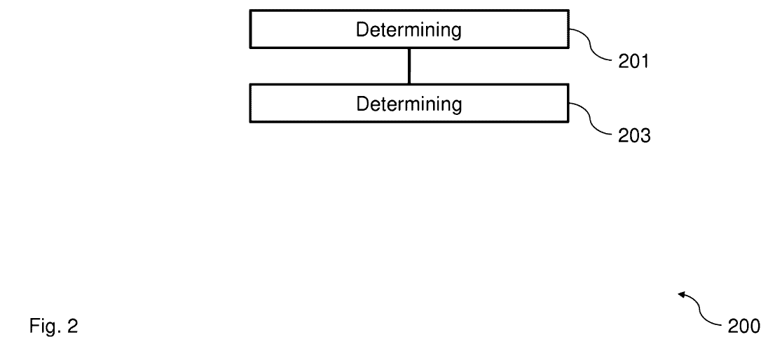

FIG. 2 shows a diagram of a method 200 for processing a digital image according to an embodiment. The digital image comprises a reference block and a plurality of further blocks.

The method 200 comprises determining 201 a plurality of similarity measures between the reference block and the plurality of further blocks, wherein each similarity measure indicates a similarity between a noise distribution in the reference block and a noise distribution in a further block of the plurality of further blocks, and determining 203 a plurality of similar blocks from the plurality of further blocks upon the basis of the plurality of similarity measures.

The method 200 can be performed by the image processing apparatus 100.

In the following, further implementation forms and embodiments of the image processing apparatus 100 and the method 200 are described in more detail.

Embodiments of the application can relate to the field of computer vision and computational photography, in particular to visual quality enhancement and noise reduction in digital images and videos, e.g. recorded by digital cameras or mobile phones.

Embodiments of the application can be applied for a block-based de-noising of a digital image comprising non-stationary Gaussian noise.

Embodiments of the application can address the topic of digital image de-noising. Many noise types can corrupt a quality of digital images e.g. recorded by digital cameras, e.g. photon shot noise caused by quantum fluctuations of light, fixed pattern noise due to hardware deficiencies, dark current noise caused by heat, amplifier noise, and/or quantization noise.

Noise reduction within digital images can be an important task in many applications. Although modern digital image sensors can provide an improved image quality, noise may not be avoided due to physical limitations, e.g. of an underlying capturing system. The challenge can even become more noticeable since digital image sensor manufacturers may tend to pack an increasing pixel number per unit area. In particular for smart-phone cameras, noise removal can be more challenging because of a decreased pixel size.

Algorithmic solutions for an effective noise reduction can be applied to recover de-noised digital images with an improved visual quality. Different techniques can be used for noise reduction, e.g. block-based methods, transform domain methods, machine learning based methods, spatial domain methods, and/or hybrid methods. Despite the amount of work done in this domain, noise in digital images and videos is still a challenge to be solved in computational photography.

Block-based approaches such as Block Matching 3-Dimensional (BM3D), Non-Local Means (NLM) or Unsupervised Information-Theoretic Adaptive (UINTA) and optimal spatial adaptation techniques can be efficient. Block-based methods can e.g. take advantage of a similarity of small blocks inside the digital image of interest. An exemplary structure of block-based approaches comprises the following three steps.

Firstly, a block matching (BM) can aim to find a plurality of similar blocks for every selected reference block in the digital image. These blocks can be stacked over each other in order to form a 3D array.

Secondly, a collaborative filtering exploiting block redundancy and/or block similarity can apply various filtering techniques. An elimination of noise components can e.g. be realized considering redundancy among the blocks of each 3D array. Once filtered, the de-noised blocks can be moved to their original positions in the digital image.

Thirdly, an aggregation can be performed. After the blocks are re-positioned into their original positions within the digital image, appropriate weights can be applied in order to estimate final pixel intensities in possibly overlapping areas within the digital image. The assigned weights may generally depend on the filtering technique used in the previous step.

A specific approach for BM in 3D with de-noising is denoted as BM3D. It can follow the steps described above, wherein the BM can give a set of 3D arrays of similar blocks with their stored position coordinates as output. The collaborative filtering can then be performed. A 3D transform can firstly be applied, followed by a filtering operation using a threshold operator and/or a statistical filtering. Ultimately, a re-conversion of noise-reduced blocks into the spatial domain can be achieved by an application of an inverse 3D transform. As a result, a set of 3D arrays with noise-reduced blocks can be re-gained after collaborative filtering. The aggregation can finally be realized, wherein the estimated noise-reduced blocks in the 3D arrays can be scattered back to their original positions in the digital image with an appropriate weighting of the overlapping blocks.

A further specific approach for non-local means de-noising is denoted as NLM. This approach can follow the steps described above, wherein BM can be realized depending not on a spatial proximity of considered blocks to the reference block but rather on a similarity of their neighborhoods. Filtering can then be performed in spatial domain without an application of 3D transforms and aggregation weights can be proportional to the BM similarity measures indicating a neighborhood similarity.

These approaches assume a stationary noise distribution and/or a Gaussian noise distribution with a constant single standard deviation across the digital image. In practice, this assumption may not be valid, e.g. based on analyses on implemented digital image sensors. In fact, the noise statistics can depend on image features of the digital image, e.g. luminosity and texture of the digital image, which may suggest a non-stationary noise model. In other words, in real world scenarios, noise statistics may not evince the same standard deviation across the entire digital image. Many factors, for example a luminosity of a scene, a gradient change or local textural information can contribute to noise characteristics across the same digital image. As a result, also the standard deviation of Gaussian noise can be regarded as being dependent on such factors denoted as image feature measures.

Embodiments of the application can apply a non-local de-noising algorithm aiming at adaptively treating real non-stationary Gaussian noise. The de-noising approach can be block-based and can comprise three steps, namely BM, filtering, and aggregation. The steps can be modified in order to efficiently remove non-stationary Gaussian noise from the digital image.

In the BM, a modification of a similarity criterion can be performed e.g. by adding an additional term taking into consideration noise characteristics, e.g. to obtain a similar standard deviation between the reference block and a similar block. In the filtering, a modification can be performed by adaptively using a noise level, e.g. a standard deviation, of the block at hand, instead of using a globally constant standard deviation. In the aggregation, a weighting can be applied adaptively according to the noise level, e.g. standard deviation, of the overlapping blocks. The modifications can result in an improved performance e.g. in terms of an image noise reduction in digital images captured by mobile phones and cameras.

In specific approaches, it is assumed that image noise can be described by a stationary Gaussian distribution with a constant standard deviation σ. This may lead to a sub-optimal noise removal performance because the applied statistics may not properly model the real image noise. In practice, an examination of noise characteristics usually shows a non-stationary Gaussian distribution, wherein the noise level can depend on specific image feature measures, e.g. intensity. Other image feature measures can be an intensity gradient or a local texture of the digital image. In the following, such criteria are denoted as image feature measures.

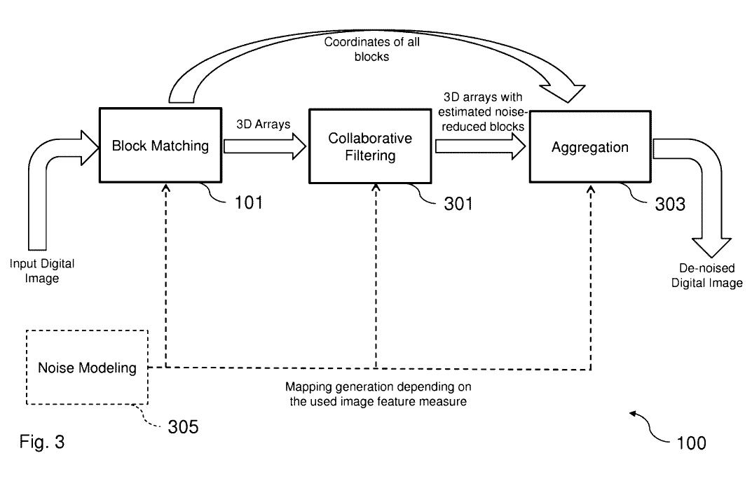

FIG. 3 shows a diagram of an image processing apparatus 100 for processing a digital image according to an embodiment. The diagram further illustrates a flowchart for a de-noising approach. The image processing apparatus 100 forms a possible implementation of the image processing apparatus as described in conjunction with FIG. 1.

The image processing apparatus 100 comprises a determiner 101, a de-noising filter 301, a combiner 303, and a further determiner 305. The determiner 101 can be configured to perform a BM within an input digital image. The de-noising filter 301 can be configured to collaboratively filter 3D arrays provided by the determiner 101. The combiner 303 can be configured to perform an aggregation upon the basis of 3D arrays with estimated noise-reduced blocks provided by the de-noising filter 301. The aggregation can further be performed upon the basis of coordinates of all blocks provided by the determiner 101. The combiner can be configured to provide a de-noised digital image. The further determiner 305 can be configured to perform a noise modelling for a mapping generation depending on the used image feature measures. The mapping can be provided to the determiner 101, the de-noising filter 301, and/or the combiner 303.

The de-noising approach can comprise the described steps for achieving an adaptive de-noising of digital images, wherein the digital images can e.g. comprise non-stationary Gaussian noise. The sequence of operations can be performed as described, wherein the steps can be modified in order to address non-stationary noise statistics apparent in real scenarios.

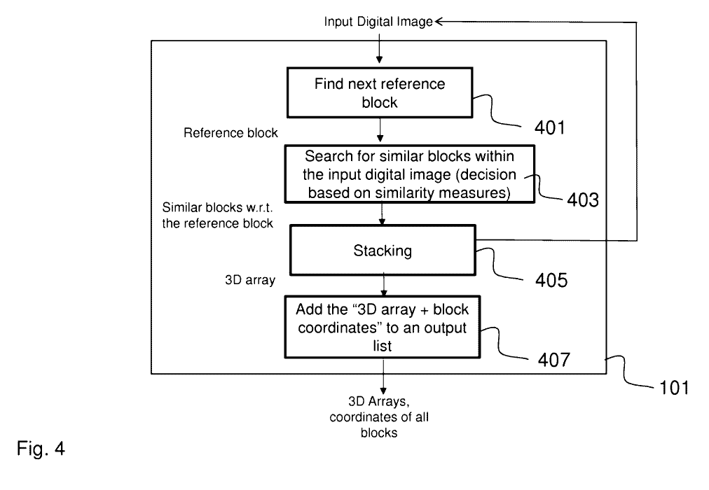

FIG. 4 shows a diagram of a determiner 101 for determining a plurality of similarity measures between a reference block and a plurality of further blocks according to an embodiment. The determiner 101 forms a possible implementation of the determiner 101 as described in conjunction with FIG. 1. The determiner 101 comprises a finder 401, a searcher 403, a stacker 405, and an adder 407. The diagram illustrates a BM.

The finder 401 can be configured to find a next reference block within the input digital image. The searcher 403 can be configured to search for similar blocks within the input digital image using a reference block, wherein the decision can be based on the similarity measures. The stacker 405 can be configured to stack similar blocks with regard to the reference block to provide a 3D array. The adder 407 can add the 3D array and block coordinates to an output list to provide the 3D arrays and coordinates of all blocks.

A reference block can be chosen within the input digital image by the finder 401. A set of similar blocks with regard to a reference block within the input digital image can be searched by the searcher 403, wherein overlapping blocks can be considered. A decision based on similarity can be performed with respect to a composed similarity criterion. A similarity criterion can e.g. be defined by calculating a quadratic distance between the blocks, e.g. a norm of a pixel-wise difference between two blocks, added to a second term comparing a comprised noise level in both blocks.

A standard deviation defining a noise level of each block can be obtained from a pre-stored mapping using single and/or combinations of image feature measures. As an example, an average intensity value of all pixels in a block can be calculated and a standard deviation from the mapping corresponding to this intensity can be looked for.

The de-noising of a given input digital image can start with the BM by the determiner 101. Each digital image can be divided into a fixed number of squared blocks having a fixed size k×k. For each block in the digital image, i.e. reference block in the digital image, an overlapping search can be conducted by the finder 401 in the input digital image within a fixed search window size of n×n pixels, e.g. centered around a position of a reference block. A search can be conducted by the searcher 403 to find the best matching similar blocks within the search window area relevant for each reference block. The selection can be performed by minimizing a similarity measure or similarity metric quantifying a difference between the reference block and the similar block at hand. The similarity measure used for deciding about the similarity can be an average pixel-wise intensity difference of the blocks. However, any other similarity measure can be applied as a first term of the equation.

In order to take into consideration non-stationary noise, a noise level similarity term can be added, comparing noise statistics estimated in different blocks. The noise level can be described by a standard deviation of a noise distribution estimated by a noise modeling performed by the further determiner 305, which can be performed offline.

The similarity measure, realizing a similarity criterion or similarity metric, for BM can be determined, for example, according to the following equation:

$$d ( {x}_{r} , {x}_{s} ) = [ {\sum }_{0 < i , j < k} {‖ {x}_{r} ( i , j ) - {x}_{s} ( i , j ) ‖}^{2} ] + α \vert {σ}_{r} - {σ}_{s} \vert ,$$

wherein xᵣ denotes intensities of a reference block, xₛ denotes intensities of a further block, i denotes a pixel position, j denotes a pixel position, k denotes a length or width of a block, α denotes a scaling factor, σᵣ denotes a standard deviation of a noise distribution of the reference block, σₛ denotes a standard deviation of a noise distribution of the further block, and d denotes the similarity measure. The first summand can indicate a quadratic distance between the intensities of the reference block and the intensities of the further block. The second summand can indicate a similarity of a noise distribution of the reference block and a noise distribution of the further block. Therefore, a pixel-wise calculation of the similarity measure d(xᵣ, xₛ) for all pixels of a block can be performed.

In other words, in order to calculate d(xᵣ,xₛ) between a reference block and a further block under non-stationary noise, a noise distribution similarity measure can be added to an intensity distribution similarity measure. The noise distribution similarity measure can be a weighted difference between a noise level of the reference block and the further block, e.g. difference between the standard deviations defining the noise level of each block.

The scaling factor α can be applied to the difference. The scaling factor can be predetermined. The scaling factor can be constant and can be determined empirically. A suitable scaling factor can e.g. be α=0.3.

A set of similar blocks with regard to the chosen reference block can be stacked over each other by the stacker 405 in order to form a 3D array.

For every reference block from the input digital image, a BM can be realized by the adder 407. The output can be a set of 3D arrays containing similar blocks stored together with their respective position coordinates.

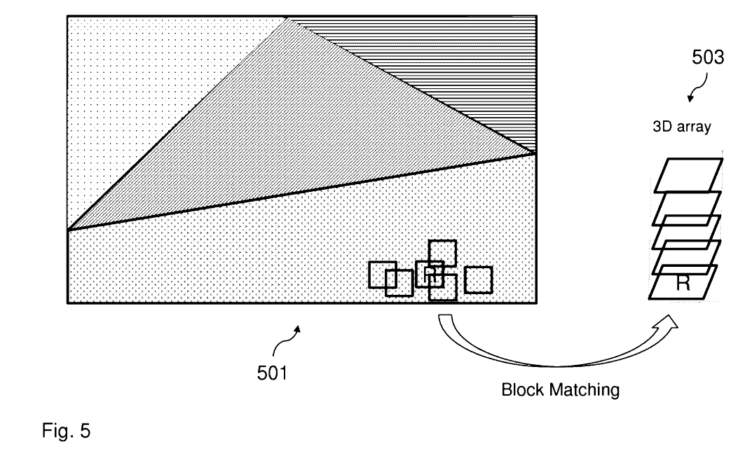

FIG. 5 shows a diagram of a digital image 501 and a 3D array 503 according to an embodiment. The digital image 501 comprises a reference block indicated as “R”, and a plurality of similar blocks, wherein the reference block and the plurality of similar blocks are square. The 3D array 503 comprises the reference block and the plurality of similar blocks stacked over each other. The diagram illustrates a BM and a 3D array generation for a single reference block.

A predetermined, e.g. maximum, number N of most similar blocks can be retained for each reference block. These can be gathered and stacked vertically over each other by the stacker 405 forming the 3D array 503. The 3D array 503 can further comprise position coordinates of each block. The choice of the reference block by the finder 401 within the input image digital and the search by the searcher 403 can result in overlapping blocks. The output of the determiner 101 can provide a list of 3D arrays.

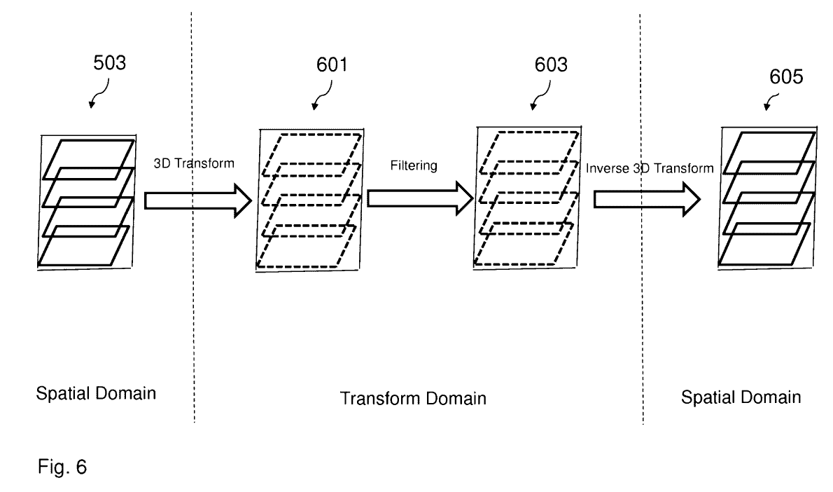

FIG. 6 shows a diagram of collaboratively filtering a 3D array 503 by a de-noising filter 301 according to an embodiment. The de-noising filter 301 can form a possible implementation of the de-noising filter described in conjunction with FIG. 1. The diagram further comprises a transformed 3D array 601, a filtered transformed 3D array 603, and a filtered 3D array 605.

The de-noising filter 301 can be configured to arrange the reference block and the plurality of similar blocks to form the 3D array 503, and to collaboratively filter the 3D array 503 to obtain a filtered reference block and a plurality of filtered similar blocks.

The de-noising filter 301 can be configured to transform the 3D array 503 from a spatial domain into a transform domain to obtain the transformed 3D array 601, to collaboratively filter the transformed 3D array 601 in the transform domain to obtain the filtered transformed 3D array 603, and to inversely transform the filtered transformed 3D array 603 from the transform domain into the spatial domain to obtain the filtered 3D array 605, wherein the filtered 3D array 605 comprises the filtered reference block and the plurality of filtered similar blocks.

The de-noising algorithm can be performed by the de-noising filter 301. The algorithm can comprise several steps for regaining a set of 3D arrays with noise-reduced blocks.

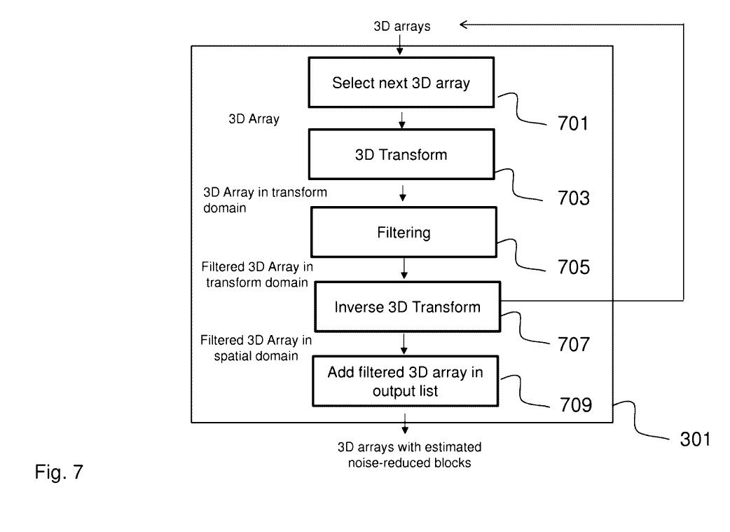

FIG. 7 shows a diagram of a de-noising filter 301 for collaboratively filtering a 3D array according to an embodiment. The de-noising filter 301 forms a possible implementation of the de-noising filter 301 as described in conjunction with FIG. 1. The diagram illustrates a collaborative filtering.

The de-noising filter 301 comprises a selector 701, a transformer 703, a filter 705, an inverse transformer 707, and an adder 709. The selector 701 can be configured to select the next 3D array from a plurality of 3D. The transformer 703 can be configured to perform a 3D transform on the 3D array. The filter 705 can be configured to filter the 3D array in a transform domain. The inverse transformer 707 can be configured to perform an inverse 3D transform on the filtered 3D array in the transform domain. The adder 709 can be configured to add the filtered 3D array in a spatial domain in an output list to provide 3D arrays with estimated noise-reduced blocks.

Firstly, a 3D array can be selected by the selector 701 from a set of 3D arrays. A 3D transform operation can be applied by the transformer 703 on the 3D array, followed by a filtering by the filter 705 to reduce noise components in the blocks, followed by an inverse 3D transform by the inverse transformer 707 to compute the corresponding spatial domain values. The resulting 3D array comprising noise-reduced blocks can be added to an output set of 3D arrays comprising noise-reduced blocks by the adder 709.

In other words, a single 3D array can be selected by the selector 701 from a list resulting after BM. A sparsity enforcing 3D transform can be applied by the transformer 703 on the 3D array having the objective of simplifying the filtering. A filtering can be applied by the filter 705 for jointly de-noising the blocks inherent in the 3D arrays e.g. by using threshold mechanisms or statistical filtering mechanisms. This can be carried out by exploiting a redundancy and/or similarity among the blocks. This can further be realized adaptively depending on the reference block standard deviation determined from a measure-to-noise mapping, wherein a measure can be an image feature measure such as gradient, luminosity, and/or color ramp.

A specific part of the approach is introduced for the filter 705 as a modification of the filtering operation used for jointly removing inherent noise by exploiting redundancy between different blocks comprised by the same 3D array. Different threshold mechanisms and/or statistical filters can be implemented in an adaptive way depending on the comprised noise in each block. Instead of using a globally constant standard deviation, the approach can be based on a modified threshold mechanism to use the corresponding standard deviation regarding the block at hand. This corresponding level can generally be determined by the block relevant standard deviation, e.g. obtained from a measure-to-noise mapping defined during a noise modeling employed by the further determiner 305.

A modified collaborative filtering using a hard threshold mechanism can be performed according to the following equation:

$$δ ( x ) = \{ \begin{matrix}0 & if \vert x \vert < {λ}_{3 D} {σ}_{{x}_{r}} \\ x & otherwise\end{matrix} \} ,$$

wherein x denotes a coefficient in the transform domain, λ_{3D} denotes a predetermined threshold factor, σₓᵣ denotes the standard deviation of the corresponding reference block, and δ denotes a filtered coefficient in the transform domain.

A modified collaborative filtering using a Wiener filtering mechanism can be performed according to the following equation:

$${C}_{{x}_{r}} = \frac{{‖ {τ}_{3 D} ( {P}_{{x}_{r}} ) ‖}^{2}}{{‖ {τ}_{3 D} ( {P}_{{x}_{r}} ) ‖}^{2} + {σ}_{{x}_{r}}} ,$$

wherein τ_{3D} denotes a predetermined functional mapping, Pₓᵣ denotes a coefficient in the transform domain, σₓᵣ denotes the standard deviation of the corresponding reference block, and Cₓᵣ denotes a filtered coefficient in the transform domain.

An inverse 3D transform can be applied by the inverse transformer 707 back on the filtered 3D array in order to recover the estimated de-noised blocks. The filtered 3D array comprising the de-noised blocks can be added to an output list by the adder 709. The result can be a set of filtered 3D arrays comprising estimated noise-reduced blocks.

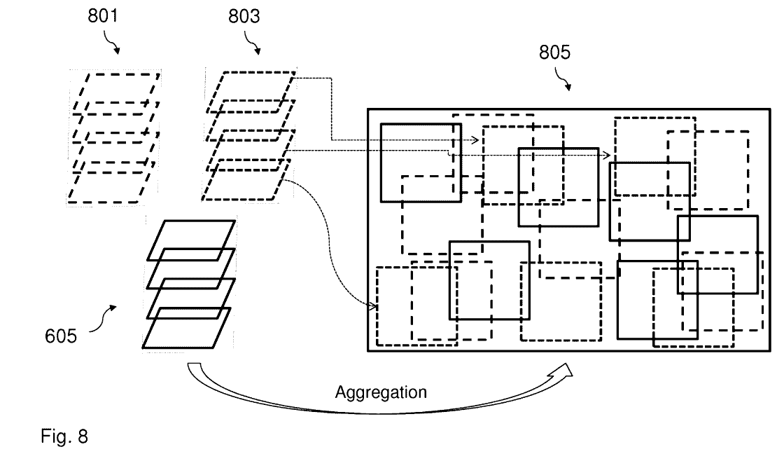

FIG. 8 shows a diagram of combining a filtered reference block with a plurality of filtered similar blocks by a combiner 303 to obtain a de-noised digital image 805. The combiner 303 forms a possible implementation of the combiner 303 as described in conjunction with FIG. 1. The diagram illustrates an aggregation for bringing back noise-reduced blocks to their original positions in the digital image in order to obtain the de-noised digital image 805.

The filtered reference block and the plurality of filtered similar blocks are comprised by a filtered 3D array 605. A further filtered reference block and a further plurality of filtered similar blocks are comprised by a further filtered 3D array 801. A further filtered reference block and a further plurality of filtered similar blocks are comprised by a further filtered 3D array 803.

The aggregation of the de-noising approach can be performed by the combiner 303. Given a set of 3D arrays comprising noise-reduced blocks and position coordinates of all blocks, an aggregation of the overlapping resulting de-noised blocks can be realized after scattering them back to their original positions in the digital image. The aggregation can be achieved by assigning appropriate weighting factors to the scattered blocks at every pixel position in the digital image and a corresponding normalization in order to determine an optimal intensity value. The choice of the weights can generally be related to the choice of the filtering mechanism used by the filter 705 within the de-noising filter 301. The aggregation weights can be determined according to the following equations, wherein a constant standard deviation can be replaced by a block dependent standard deviation.

In other words, the filtered estimated noise-reduced blocks in the 3D arrays can be scattered back to their original positions within the digital image by the combiner 303. An over-complete representation of the digital image, e.g. because overlapping blocks from different 3D arrays corrupt the original digital image, can be recovered since some of them may overlap. An appropriate aggregation can be achieved by awarding a proper weighting for the overlapping blocks in order to estimate pixel values at shared positions.

The aggregation weights can e.g. be determined after a hard threshold filtering mechanism according to the following equation:

$${w}_{{x}_{r}} = \{ \frac{1}{{σ}_{{x}_{r}}^{2} {N}_{{x}_{r}}} \} ,$$

wherein σₓᵣ denotes the standard deviation of the corresponding reference block, Nₓᵣ denotes a number of zero-valued coefficients in the transform domain, and wₓᵣ denotes an aggregation weight.

The aggregation weights can e.g. be determined after a Wiener filtering mechanism according to the following equation:

wₓ_{ᵣ}=σₓ_{ᵣ}⁻²∥Cₓᵣ∥⁻²,

wherein σₓᵣ denotes the standard deviation of the corresponding reference block, Cₓᵣ denotes the filtered coefficient in the transform domain, and wₓᵣ denotes an aggregation weight.

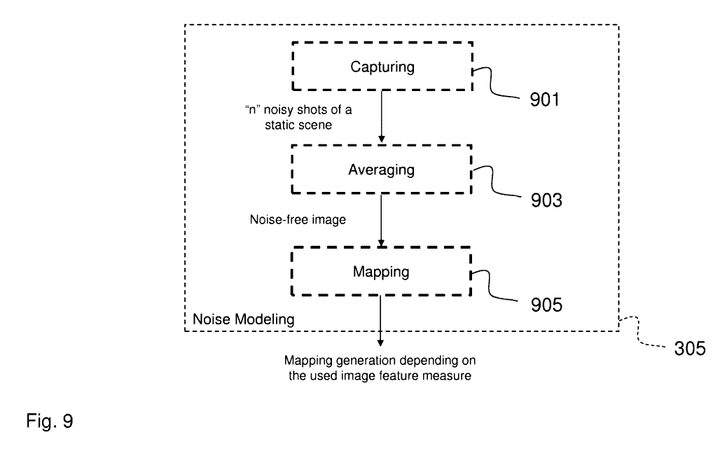

FIG. 9 shows a diagram of a further determiner 305 for determining a plurality of image feature measures and a plurality of noise indicators upon the basis of a plurality of further digital images according to an embodiment. The further determiner 305 forms a possible implementation of the further determiner 305 as described in conjunction with FIG. 1. The diagram illustrates a noise modeling.

The further determiner 305 comprises a capturer 901, an averager 903, and a mapper 905. The capturer 901 can capture the plurality of further digital images to provide n noisy shots of a static scene. The averager 903 can average the noisy shots of the static scene to provide a noise-free digital image. The mapper 905 can perform a mapping generation depending on the used image feature measure.

For evaluating the approach, a pre-processing for noise modeling in digital images can be realized together with a statistical analysis of its properties. It can be aimed to estimate statistical properties, e.g. a standard deviation, provided by real digital image sensors, assuming that real noise is Gaussian distributed. This assumption can be confirmed by the fact that camera noise can originate from many types of noise. Averaging many different types of distributions can tend to approximate a Gaussian distribution, according to the central limit theorem.

The assumption about a noise model described by a single constant standard deviation is reconsidered. In fact, observations confirm that the standard deviation of the noise distribution of image blocks can have a dependency on its local properties, such as an average intensity or an average gradient of the blocks. This can suggest assuming a non-stationary distribution for the digital image noise, which can depend on the block at hand.

Embodiments of the application are based on an adaptive de-noising of different regions within a single digital image, under an assumption that real noise can present non-stationary statistics and can be tightly correlated to textural, geometrical and local statistics of the region within the digital image.

The statistics of the noise can depend on the nature of the capturing digital image sensor. Therefore, a first step of the approach can comprise a learning phase, in order to estimate a dependency of a standard deviation on a plurality of image feature measures, e.g. luminosity and/or texture. The learning phase can be applied on a testing dataset comprising the further digital images of different properties, e.g. gradient, luminosity and texture, recorded by a set of capturing systems. As a result, a parametric model can be computed which can determine the standard deviation in dependence of the considered block within the digital image. This way, each block can be assigned an individual standard deviation.

For sake of simplicity, an example of a local intensity and noise level correlation is described in more detail. Accordingly, further image feature measures such as gradient, color, and/or textural content can have a corresponding influence on a local noise level within the digital image.

A clustering mechanism can be applied to describe the correlation. When a categorization of the digital image sensor is performed on the basis of luminosity, for example, pixels with similar intensity, e.g. in color-space or grayscale, can be assigned to the same cluster. Every single cluster can be disposed a standard deviation qualifying the corresponding noise level. The mapping between a luminosity cluster “I” and a standard deviation σ of the noise distribution can be described by:

I [symbol] σ.

This can mean that the standard deviation σ can be described as a function:

σ(I).

The de-noising approach can be based on the mapping. Instead of assuming a stationary, constant standard deviation for all blocks, every single block can be treated separately according to its contained intensities and standard deviation. An average standard deviation of a noise distribution in a block can vary according to the considered image feature measures, such as intensity, and/or gradient. This dependence can be described by the mapping from the measures to the standard deviation.

Using intensity as an image feature measure, the average intensity of each block can be calculated. The corresponding standard deviation can be assigned to this value, according to the mapping. The de-noising can be performed block-wise using the assigned standard deviation.

In other words, the pre-processing can be based on a statistical analysis of natural noise properties, e.g. a standard deviation, in the case of real digital image sensors, assuming that noise is Gaussian. This assumption is confirmed by the fact that camera noise can originate from many different types of noise. Averaging many different types of noise distributions tends to approximate a Gaussian noise distribution, according to the central limit theorem. The observations confirm that the standard deviation of the noise distribution of every block has a dependency on its local image feature properties, such as an average intensity or an average gradient of the block. Therefore, embodiments of the application use a non-stationary noise distribution for the image noise, which depends on the block at hand.

The further determiner 305 can perform the noise modeling, aiming at estimating how the noise statistics vary in real digital image sensors according to different image feature measures, e.g. intensity, gradient, and/or texture. The further determiner 305 can perform an approach for modeling a correlation between non-stationary noise statistics and textural and/or geometrical local features or specificities of every image block.

The approach can comprise a learning phase applied on a testing dataset of further digital images with different properties recorded by a set of capturing systems associated with the capturer 901. This phase can have the objective of estimating and graphically approximating a dependency of a noise standard deviation on a plurality of image feature measures, e.g. luminosity, gradient, and/or texture, assuming a de-noised ground truth digital image is available. The de-noised ground truth digital image can be determined e.g. by averaging a plurality of further digital images depicting the same scene and can be performed by the averager 903. As a result, a parametric model can be computed by the mapper 905. The mapper 905 can determine a standard deviation in dependence of image feature measures characterizing the block at hand. This way, each block can be assigned an individual standard deviation describing a comprised noise level.

A capturing of n noisy digital image frames of further digital images of a static scene can be realized in the same conditions by the capturer 901. Only a single digital image of the recorded noisy digital images may be used as a noisy input digital image. The averaging carried out by the averager 903 can be aimed at computing an approximate ground truth, e.g. noise-free, digital image. The noise modeling can be carried out by the mapper 905 depending on the chosen image feature measure, e.g. luminosity, gradient, and/or color ramp, or a combination of image feature measures in order to define the mapping. In this example, an intensity-to-noise mapping is provided.

In an embodiment of the application, the noise modeling is performed offline and the output, e.g. a measure-to-noise mapping, is stored or pre-defined before applying the de-noising approach. The de-noising can be performed online, i.e. on-the-fly.

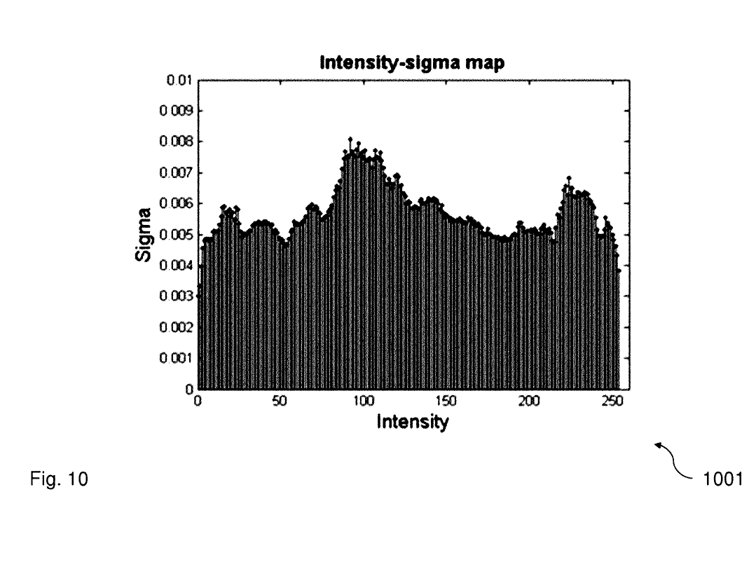

FIG. 10 shows a diagram of a plurality of stored image feature measures and a plurality of stored noise indicators being arranged to form a measure-to-noise map 1001 according to an embodiment. The plurality of stored image feature measures, the plurality of stored noise indicators, and/or the measure-to-noise map 1001 can be stored in a memory of the image processing apparatus 100. The diagram illustrates a measure-to-noise mapping, in particular an intensity-to-sigma mapping. The noise is indicated by a corresponding standard deviation.

When a categorization of a digital image sensor is performed on the basis of a local image feature measure, e.g. based on an intensity measure in color-space or grayscale, corresponding pixels having the same intensity can be assigned to the same cluster. For each single cluster, the noise standard deviation can be estimated determining the corresponding noise level. The mapping e.g. between luminosity cluster I and standard deviation σ of the noise distribution can mathematically be described by I→σ and the standard deviation σ can be described as a function σ(I).

Embodiments of the application can be directed to adapting block-based approaches for de-noising to achieve an adaptive de-noising of digital images comprising non-stationary Gaussian noise. The approach can be employed for digital image de-noising comprising, given a certain digital image sensor, the following steps: learning of noise statistics given a single image feature measure or a combination of associated image feature measures, e.g. luminosity, texture, and/or color, applying a block based de-noising mechanism with filtering on high-frequencies, and an adaptive de-noising applying threshold mechanisms or statistical filtering mechanisms on the basis of the learned statistics.

The determination of a noise level of a block, e.g. σᵣ or σₛ, can be performed within the noise modeling. The noise level can be computed offline. A learning phase can be applied on a predetermined set of further digital images, e.g. testing images, in order to learn noise standard deviation values depending on a plurality of image feature measures, e.g. luminosity, texture, and/or color, under noise considerations. This can be performed offline. For example, the measure-to-noise map or histogram can be computed offline and can be pre-stored. Thus, the noise modeling can be performed offline and the measure-to-noise mapping can be stored or predetermined before applying the de-noising.

Given an input digital image, the actual de-noising can be performed by considering offline learned noise standard deviations. That is, for each block of the input digital image, the value of σ can be determined based on actual image feature measures such as luminosity, gradient, texture, and other parameters of the corresponding block, which can be mapped onto the pre-stored map or histogram. In this way, each block in the input digital image can be assigned an individual standard deviation depending on the noise level. This can be performed online, i.e. on-the-fly. Based on the assigned σ values of the blocks, the best matching and/or similar blocks for each reference block can be selected according to the provided equation regarding similarity measures.

Throughout the description, the following definitions of acronyms and glossaries are used: 3D denotes three-dimensional space, a digital image denotes a visual representation of a real world or synthetic scene by a digital camera and can also be referred to as a picture, a pixel denotes the smallest addressable image or picture element, a block denotes a block of pixels extracted from an image, a 3D array denotes an array comprising similar blocks stacked over each other, a sparse signal denotes a signal that can be described by only few coefficients in a transform domain, BM denotes an approach or algorithm to search for similar blocks with regard to a reference block within a digital image, collaborative filtering denotes a filtering approach, wherein instead of considering a single block to filter, multiple blocks stacked on top of each other, forming a 3D array, can jointly be filtered with keeping into consideration a correlation among them, aggregation denotes a weighted averaging of different intensity estimates brought by overlapping blocks at a certain pixel position, a ground truth denotes a resulting noise-free image after averaging a set of n noisy image frames of the same scene, a Gaussian distribution, also called a normal distribution, denotes a continuous symmetrical bell-shaped probability function described by a mean value μ and a positive standard deviation, a measure denotes a characteristic property in a digital image used generally to extract information from it e.g. an intensity, gradient, and/or color ramp, and can be generally correlated with a local noise level, a standard deviation denotes a value measuring an amount of variation or dispersion from a mean, and can be a reported margin of an error against a true value, a mapping denotes a graphic representation of relationships between data sets, and can be a parametric model of a correlation between an image noise and a considered measure, e.g. a gradient, luminosity, and/or color ramp, a quadratic distance denotes a distance metric quantifying a similarity between two digital images and/or blocks, and can be calculated as a norm of a pixel-wise difference between the digital images and/or blocks, and noise denotes a random, e.g. not present in the captured scene, variation of brightness, textural, gradient or color in an image.

What is claimed is:

1. An image processing apparatus for processing a digital image, wherein the digital image comprises a reference block and a plurality of further blocks, and wherein the image processing apparatus comprises:
a non-transitory computer readable medium having instructions stored thereon; and
a computer processor coupled to the non-transitory computer readable medium and being configured to:
determine a plurality of similarity measures between the reference block and the plurality of further blocks, wherein each similarity measure indicates a similarity between a noise distribution in the reference block and a noise distribution in a further block of the plurality of further blocks; and
determine a plurality of similar blocks from the plurality of further blocks upon the basis of the plurality of similarity measures.

2. The image processing apparatus of claim 1, wherein each similarity measure further indicates a similarity between an intensity distribution in the reference block and an intensity distribution in the further block of the plurality of further blocks.

3. The image processing apparatus of claim 1, wherein the computer processor is further configured to execute the instructions to:
partition the digital image into a plurality of blocks; and
determine the reference block and the plurality of further blocks from the plurality of blocks.

4. The image processing apparatus of claim 1, wherein a size of the reference block and a size of a further block of the plurality of further blocks are equal.

5. The image processing apparatus of claim 1, wherein the reference block is rectangular.

6. The image processing apparatus of claim 1, wherein a further block of the plurality of further blocks is rectangular.

7. The image processing apparatus of claim 1, wherein the plurality of further blocks is arranged within a search window area associated with the reference block, wherein the search window area comprises the reference block, and wherein the search window area has a predetermined size.

8. The image processing apparatus of claim 1, wherein the computer processor is further configured to execute the instructions to:
determine a reference noise indicator indicating the noise distribution in the reference block;
determine a plurality of further noise indicators indicating the noise distributions in the plurality of further blocks; and
combine the reference noise indicator with the plurality of further noise indicators to determine the plurality of similarity measures between the reference block and the plurality of further blocks.

9. The image processing apparatus of claim 8, wherein the computer processor is further configured to execute the instructions to:
determine a reference image feature measure, in particular an average intensity, of the reference block;
determine a plurality of further image feature measures, in particular average intensities, of the plurality of further blocks;
determine the reference noise indicator upon the basis of the reference image feature measure; and
determine the plurality of further noise indicators upon the basis of the plurality of further image feature measures.

10. The image processing apparatus of claim 9, wherein the non-transitory computer readable medium is configured to store a plurality of stored image feature measures and a plurality of stored noise indicators, wherein each stored image feature measure is associated with a stored noise indicator, and wherein the computer processor is further configured to execute the instructions to compare the reference image feature measure or a further image feature measure with the plurality of stored image feature measures in the memory, and to retrieve a stored noise indicator from the memory being associated with a stored image feature measure corresponding to the reference image feature measure or the further image feature measure.

11. The image processing apparatus of claim 10, wherein the computer processor is further configured to execute the instructions to:
determine a plurality of image feature measures and a plurality of noise indicators upon the basis of a plurality of further digital images, wherein each image feature measure is associated with a noise indicator; and
store the determined plurality of image feature measures and the determined plurality of noise indicators in the non-transitory computer readable medium.

12. The image processing apparatus of claim 1, further comprising a de-noising filter, wherein the de-noising filter is configured to:
arrange the reference block and the plurality of similar blocks to form a 3-dimensional array; and
collaboratively filter the 3-dimensional array to obtain a filtered reference block and a plurality of filtered similar blocks.

13. The image processing apparatus of claim 12, wherein the computer processor is further configured to execute the instructions to:
determine a reference noise indicator indicating the noise distribution in the reference block; and
determine a plurality of further noise indicators indicating the noise distributions in the plurality of further blocks, and
wherein the de-noising filter is configured to collaboratively filter the 3-dimensional array upon the basis of the reference noise indicator associated with the reference block and further noise indicators associated with the plurality of similar blocks.

14. The image processing apparatus of claim 12, wherein the de-noising filter is configured to:
transform the 3-dimensional array from a spatial domain into a transform domain to obtain a transformed 3-dimensional array;
collaboratively filter the transformed 3-dimensional array in the transform domain to obtain a filtered transformed 3-dimensional array; and
inversely transform the filtered transformed 3-dimensional array from the transform domain into the spatial domain to obtain the filtered reference block and the plurality of filtered similar blocks.

15. The image processing apparatus of claim 12, further comprising a combiner, wherein the combiner is configured to combine the filtered reference block with the plurality of filtered similar blocks to obtain a de-noised digital image.

16. The image processing apparatus of claim 15, wherein the computer processor is further configured to execute the instructions to:
determine a reference position indicator indicating a position of the reference block within the digital image; and
determine a plurality of position indicators indicating positions of the plurality of similar blocks within the digital image, and
wherein the combiner is configured to combine the filtered reference block with the plurality of filtered similar blocks upon the basis of the determined reference position indicator and the determined plurality of position indicators.

17. A method for processing a digital image, wherein the digital image comprises a reference block and a plurality of further blocks, and wherein the method comprises:
determining a plurality of similarity measures between the reference block and the plurality of further blocks, wherein each similarity measure indicates a similarity between a noise distribution in the reference block and a noise distribution in a further block of the plurality of further blocks; and
determining a plurality of similar blocks from the plurality of further blocks upon the basis of the plurality of similarity measures.

18. A non-transitory computer readable medium comprising a program code for performing a method for processing a digital image when executed on a computer, wherein the digital image comprises a reference block and a plurality of further blocks, and wherein the method comprises:
determining a plurality of similarity measures between the reference block and the plurality of further blocks, wherein each similarity measure indicates a similarity between a noise distribution in the reference block and a noise distribution in a further block of the plurality of further blocks; and
determining a plurality of similar blocks from the plurality of further blocks upon the basis of the plurality of similarity measures.
